(19) United States
(12) Patent Application Publication
(10) Pub. No.: US 2017/0053363 A1
(43) Pub. Date: Feb. 23, 2017

(54) METHOD AND SYSTEM FOR PROVIDING A TRAVEL RECOMMENDATION

(71) Applicant: MasterCard International Incorporated, Purchase, NY (US)

(72) Inventors: Sourabh MAHESHWARI, Gurgaon (IN); Suneel BHATT, Delhi (IN); Amit GUPTA, New Delhi (IN)

(73) Assignee: MasterCard International Incorporated, Purchase, NY (US)

(21) Appl. No.: 15/226,177

(22) Filed: Aug. 2, 2016

(30) Foreign Application Priority Data
Aug. 18, 2015 (SG) 10201506489X

(51) Int. Cl. G06Q 50/14; G06Q 20/10

(52) U.S. Cl. CPC G06Q 50/14; G06Q 20/10

(57) ABSTRACT

The method comprising: receiving electronic payment transaction data relating to one or more aspects of travel, the aspects of travel comprising: transportation, accommodation and/or dining; receiving segment data relating to the one or more aspects of travel, the segment data comprising information corresponding to a plurality of travel segments; generating, using a recommendation module, recommendation data by associating the electronic payment transaction data with the segment data to determine, at least, a price of each of the plurality of travel segments; receiving, from a user input module, user input data indicative of (i) overall travel budget, (ii) period of travel and (iii) origin location of the user; generating, using the recommendation module, the travel recommendation based on the recommendation data and the user input data; and transmitting the travel recommendation to a user output module to provide the travel recommendation to the user.

### FIELD OF INVENTION

The present invention relates broadly, but not exclusively, to methods and systems for providing a travel recommendation to a user.

### BACKGROUND

When planning a vacation, whether overseas or domestic (e.g. another city/state within the traveller's country of residence), various aspects of travel such as transportation, accommodation, and/or dining need to be considered. Planning can be quite tedious as there are usually numerous choices available for each aspect of travel. If the traveller is restricted by a budget and/or certain dates to go on the vacation, the entire experience of planning the vacation and making the necessary bookings can be even more tedious as there needs to be additional filtering of choices.

Currently, when planning a vacation, a traveller may experience the following issues. For airline flights, numerous flight-booking web portals claim to provide the cheapest flight tickets and their rates change so frequently that it is hard for the traveller to know when to buy the flight tickets and whom to buy the tickets from. Similarly for accommodation, many accommodation-booking web portals claim to provide the best deals and their rates change so frequently that it is hard for the traveller to know when to make the reservation and whom to make the reservation with. For transportation at the vacation destination (e.g. car rental, bus rides), the traveller may not know which merchants at the vacation destination are reliable and offer reasonable rates such that the traveller may end up paying more for a lesser product. For dining at the vacation destination, the traveller may not know which restaurants at the vacation destination serve good food at reasonable prices and the traveller may end up paying a high price for an unpleasant meal.

A need therefore exists to provide methods and systems for providing a travel recommendation that seek to address at least the above-mentioned problems.

### SUMMARY

According to a first aspect of the present invention, there is provided a method for providing a travel recommendation to a user, the method comprising: receiving electronic payment transaction data relating to one or more aspects of travel, the aspects of travel comprising: transportation, accommodation and/or dining; receiving segment data relating to the one or more aspects of travel, the segment data comprising information corresponding to a plurality of travel segments; generating, using a recommendation module, recommendation data by associating the electronic payment transaction data with the segment data to determine, at least, a price of each of the plurality of travel segments; receiving, from a user input module, user input data indicative of (i) overall travel budget, (ii) period of travel and (iii) origin location of the user; generating, using the recommendation module, the travel recommendation based on the recommendation data and the user input data; and transmitting the travel recommendation to a user output module to provide the travel recommendation to the user.

In an embodiment, the method may further comprise: identifying, using the recommendation module, reference users that have a similar transactional behavior to the user; receiving electronic payment transaction data of the reference users that relate to the one or more aspects of travel; and determining, using the recommendation module, an average spend of each reference user for each of the one or more aspects of travel based on the electronic payment transaction data of the reference users, wherein the travel recommendation is based on the average spend of each reference user for each of the one or more aspects of travel, in addition to the recommendation data and the user input data.

In an embodiment, the electronic payment transaction data of the reference users may correspond to payment transactions conducted overseas, and the average spend of each reference user may comprise overseas spending.

In an embodiment, the step of identifying reference users that have a similar transactional behavior to the user may comprise: obtaining transactional behavior of the user; obtaining transactional behavior of other users; and comparing, using the recommendation module, the transactional behavior of the user with the transactional behavior of the other users to identify the reference users that have a similar transactional behavior to the user.

In an embodiment, the step of obtaining the transactional behavior of the user may comprise: receiving, from the user input module, the user's identity for uniquely identifying the user; obtaining historical data corresponding to the identified user; and determining, using the recommendation module, the transactional behavior of the user based on the historical data corresponding to the identified user.

In an embodiment, the step of obtaining the transactional behavior of the other users may comprise: obtaining historical data corresponding to the other users; and determining, using the recommendation module, the transactional behavior of the other users based on the historical data corresponding to the other users.

In an embodiment, the transactional behavior may be defined at least by an amount of money spent within a particular period of time for a particular aspect of travel.

In an embodiment, the step of comparing the transactional behavior of the user with the transactional behavior of the other users may comprise comparing the amount of money spent within the particular period of time for the particular aspect of travel, and wherein the amount of money spent within the particular period of time for the particular aspect of travel by the reference users is within a pre-defined range of the amount of money spent within the particular period of time for the particular aspect of travel by the user.

In an embodiment, the historical data may comprise historical travel data and/or the electronic payment transaction data.

In an embodiment, the electronic payment transaction data may comprise at least one of: a merchant category code (MCC), transaction date and transaction amount of an electronic payment transaction.

In an embodiment, the user's identity may comprise at least one of: an account number, a unique identifier and cardholder identification data.

In an embodiment, the method may further comprise: receiving, from the user input module, additional user input data indicative of: (i) length of travel period, (ii) desired class of travel, (iii) desired destination, and (iv) distribution of the overall travel budget among the one or more aspects of travel, wherein the travel recommendation is based on the additional user input data, in addition to the recommendation data and the user input data.

In an embodiment, the travel recommendation may comprise one or more of: (i) a recommended travel destination, (ii) a recommended transportation to the destination, (iii) a recommended accommodation at the destination and (iv) a recommended restaurant at the destination.

In an embodiment, the each travel segment may define a discrete portion of a travel itinerary relating to either transportation, accommodation or dining.

In an embodiment, the segment data may comprise one or more of: a price, validity period, location, and class corresponding to each travel segment.

In an embodiment, associating the electronic payment transaction data with the segment data may comprise linking electronic payment transaction data corresponding to a payment transaction with segment data corresponding to a travel segment that was paid through the payment transaction.

According to a second aspect of the present invention, there is provided a system for providing a travel recommendation to a user, comprising a recommendation module, the recommendation module comprising: at least one processor; and at least one memory including computer program code; the at least one memory and the computer program code configured to, with at least one processor, cause the recommendation module at least to: receive electronic payment transaction data relating to one or more aspects of travel, the aspects of travel comprising: transportation, accommodation and/or dining; receive segment data relating to the one or more aspects of travel, the segment data comprising information corresponding to a plurality of travel segments; generate recommendation data by associating the electronic payment transaction data with the segment data to determine, at least, a price of each of the plurality of travel segments; receive, from a user input module, user input data indicative of (i) overall travel budget, (ii) period of travel and (iii) origin location of the user; generate the travel recommendation based on the recommendation data and user input data; and transmit the travel recommendation to a user output module to provide the travel recommendation to the user.

In an embodiment, the recommendation module may be further caused to: identify reference users that have a similar transactional behavior to the user; receive electronic payment transaction data of the reference users that relate to the one or more aspects of travel; and determine an average spend of each reference user for each of the one or more aspects of travel based on the electronic payment transaction data of the reference users, wherein the travel recommendation is based on the average spend of each reference user for each of the one or more aspects of travel, in addition to the recommendation data and the user input data.

In an embodiment, the system may further comprise a database communicatively coupled with the recommendation module, the database having stored thereon at least one of: the electronic payment transaction data relating to one or more aspects of travel, the segment data relating to the one or more aspects of travel, and the recommendation data.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a flow chart illustrating a method for providing a travel recommendation to a user according to an example embodiment;

FIG. 2 shows a flow chart illustrating a method for providing a travel recommendation to a user according to an example embodiment;

FIG. 3 shows a schematic of a system for providing a travel recommendation to a user according to an embodiment of the invention; and

FIG. 4 shows an exemplary computing device suitable for executing the method for providing a travel recommendation to a user.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Currently, many merchants accept electronic payment transactions as an alternative to cash for the payment for products. In such electronic payment transactions, a payment card may be used. Typically, in a “card-present” electronic payment transaction, when a payment card holder (consumer) wishes to purchase a product from a merchant, the payment card holder presents his/her payment card to the merchant. The merchant typically has a point-of-sale (POS) terminal with a card reader that can interact/communicate with the payment card and facilitates the conduct of the electronic payment transaction. Payment cards are typically uniquely tied to a consumer or card holder account. As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transaction card can be used as a method of payment for performing a transaction.

The merchant typically submits a request to an acquirer (a financial institution that processes and settles the merchant's transactions with the help of an issuer). The acquirer then sends the request to the issuer (a financial institution, bank, credit union or company that issues or helps issue cards to payment card holders) to authorize the transaction. A financial institution/payment facilitator (e.g. MasterCard®) acts as an intermediary between the acquirer and the issuer. If the acquirer authorizes the transaction (e.g. there are sufficient funds/credit in the payment card holder's account), the merchant releases the product to the payment card holder.

During a typical electronic payment transaction, certain data associated with the transaction (i.e. electronic payment transaction data) may be generated and the transaction data may be captured/collected by the payment facilitator. For example, the transaction data may be uploaded to a data warehouse on a regular basis (e.g. daily, weekly, monthly). If necessary, various algorithms/rules can be applied to anonymize the transaction data so that no personally identifiable numbers are available to the users of the transaction data.

The following types of transaction data can be may be generated/captured:
Transaction level information:—
   Transaction ID
   Account ID (anonymized)
   Merchant ID
   Transaction Amount
   Transaction Local Currency Amount
   Date of Transaction
   Time of Transaction
   Type of Transaction
   Date of Processing
   Cardholder Present Code
   Merchant Category Code (MCC)
Account Information:—
   Account ID (anonymized)
   Card Group Code
   Card Product Code
   Card Product Description
   Card Issuer Country
   Card Issuer ID
   Card Issuer Name
   Aggregate Card Issuer ID
   Aggregate Card Issuer Name
Merchant Information:—
   Merchant ID
   Merchant Name
   MCC/Industry Code
   Industry Description
   Merchant Country
   Merchant Address
   Merchant Postal Code
   Aggregate Merchant ID
   Aggregate Merchant Name
   Merchant Acquirer Country
   Merchant Acquirer ID
Issuer Information:—
   Issuer ID
   Issuer Name
   Aggregate Issuer ID
   Issuer Country

The electronic payment transaction data can be used in conjunction with other types of data to provide travel recommendations to users.

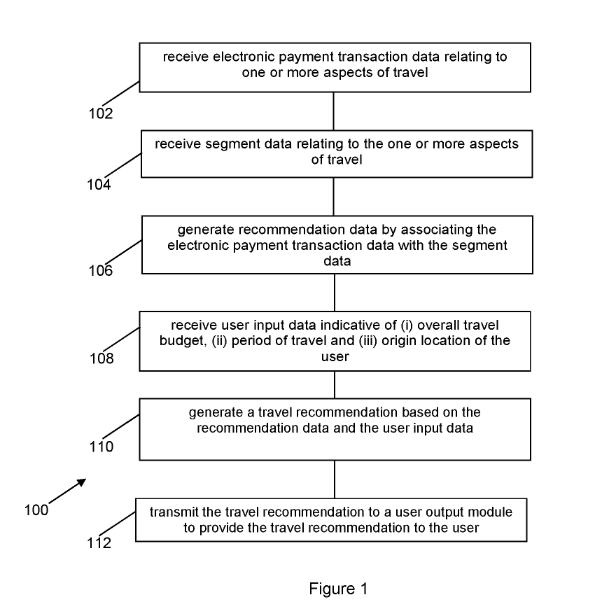

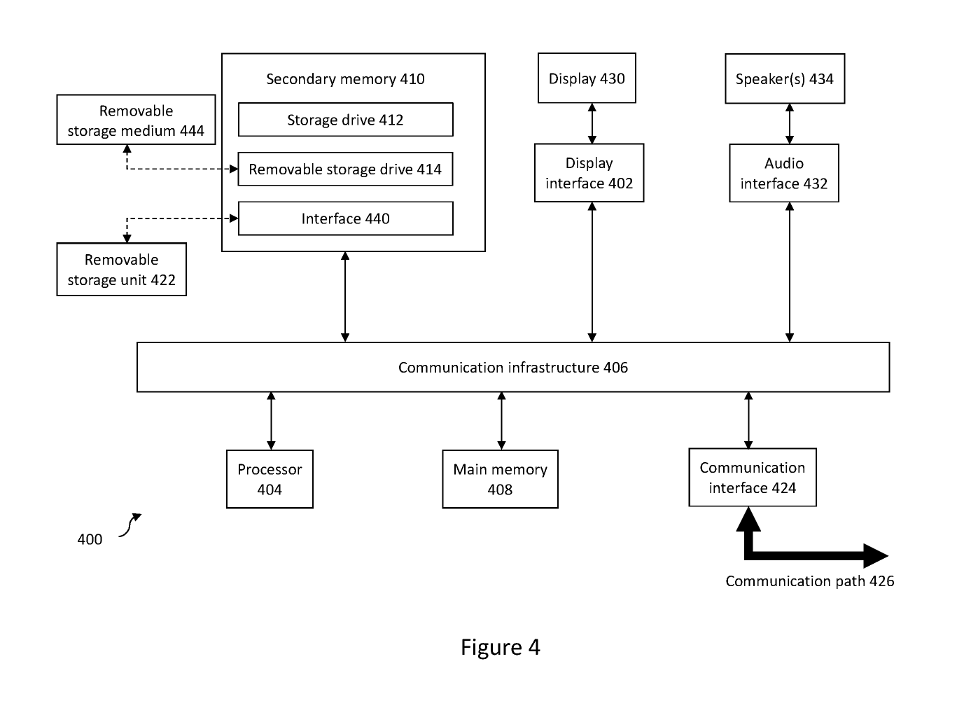

FIG. 1 shows a flow chart illustrating a method 100 for providing a travel recommendation to a user, according to an embodiment of the invention. The method 100 may be performed by a purpose-built computing device such as a recommendation module that is coupled to one or more databases. Further details on the recommendation module and databases will be provided below with reference to FIGS. 3 and 4. In the following description, the travel recommendation can be either for overseas travel or domestic travel (e.g. another city/state within the traveller's country of residence).

The method 100 comprises a step 102 of receiving electronic payment transaction data relating to one or more aspects of travel. In particular, the electronic payment transaction data relates/corresponds to electronic payment transactions conducted in relation to the one or more aspects of travel. Details on the electronic payment transaction data have been provided above. In the following description, the one or more aspects of travel include, but are not limited to, transportation, accommodation and dining. “Transportation” may include airline flights, car rental, bus rides and train rides. “Accommodation” may include lodging such as hotels, motels, inns, private homes and serviced apartments. “Dining” may include restaurants, bars, pubs and nightclubs. The merchant category code (MCC) that is part of the transaction data can be used to identify transactions relating to the one or more aspects of travel.

Step 104 involves receiving segment data relating to the one or more aspects of travel. The segment data comprises information corresponding to a plurality of travel segments. In the following description, each travel segment defines a discrete portion of a travel itinerary relating to either transportation, accommodation or dining. For example, an airline flight may comprise one segment (e.g. a direct flight from India to New York) or multiple segments (a flight from India to New York with a stop-over in Los Angeles, where the first segment is the flight from India to Los Angeles and the second segment is the flight from Los Angeles to New York). Each segment has its own segment data. The segment data may include one or more of the following details corresponding to each travel segment: price, name of merchant (i.e. airline, hotel, car rental company, restaurant, etc.), validity period, location, class, terms/conditions and any other pertinent details. For example, for the flight from Los Angeles to New York, the segment data may include a price, name of airline, class of travel, departure/arrival location and time (e.g. US$400 on economy class via XYZ Airlines; departs Los Angeles (LAX) every Tuesday at noon and arrives in New York (JFK) at 6 pm). As a further example, the segment data relating to a hotel-stay segment may include a price, name of hotel, class of hotel/room, validity period (e.g. US$500 for a Superior room in ABC hotel during June 2015, the hotel being situated on Fifth Ave., Manhattan, New York City).

The segment data may be provided by merchants, third-party aggregators, or acquirers. The segment data may also be obtained from Internet websites/web portals or other publicly-available sources of information. The segment data may be stored on a database that is different or the same as the one containing the electronic payment transaction data.

The electronic payment transaction data (received at step 102) and segment data (received at step 104) are separate and distinct sets of data. That is, based on electronic payment transaction data alone, it is not possible to determine the segment information (e.g. price, name of airline, class of travel, departure/arrival location and time). Likewise, using segment data alone, it is not possible to determine the electronic payment transaction details (e.g. when the flight ticket was purchased).

Step 106 involves using a recommendation module to generate recommendation data by associating the electronic payment transaction data with the segment data to determine, at least, a price (transaction amount) of each of the plurality of travel segments. In an implementation, the step of associating the electronic payment transaction data with the segment data may comprise associating/linking electronic payment transaction data corresponding to an electronic payment transaction with segment data corresponding to a travel segment that was paid through the electronic payment transaction. In other words, if a particular travel segment was paid through a payment transaction, details on that travel segment can be related to the details of the payment transaction (e.g. merchant category code (MCC), transaction date and transaction amount). By linking the electronic payment transaction data (received at step 102) and segment data (received at step 104), it is possible to determine the segment information corresponding to a particular electronic payment transaction; vice versa, it is possible to determine the details of the payment transaction corresponding to a particular segment.

The generated recommendation data may be stored on a database that is different or the same as the one containing the segment data/electronic payment transaction data. The generated recommendation data can be viewed as a data pool from which travel recommendations are based on.

Step 108 involves receiving, from a user input module, user input data indicative of: (i) overall travel budget, (ii) period of travel (i.e. date/time of departure and return) and (iii) origin location of the user (i.e. user's city/state/country of residence).

Step 110 involves using the recommendation module to generate the travel recommendation based on the recommendation data (generated at step 106) and the user input data (received at step 108). In an implementation, the travel recommendation may comprises one or more of: (i) recommended travel destination(s), (ii) recommended transportation options to the destination, (iii) recommended accommodation(s) at the destination and (iv) recommended restaurant(s)/bar(s) at the destination. The user may be able to select which aspects of travel (transportation, accommodation, dining, etc.) he wishes to receive travel recommendation. Alternatively, the travel recommendation may consist of all aspects of travel.

As an example, a user's travel input is: “$2000 overall budget for a vacation; 5 days of vacation starting 1 Jun. 2015 and return 5 Jun. 2015; and current location is Germany”. For simplicity, assume that the user wishes to obtain a recommendation for lodging only. The travel recommendation may be a list of all hotels in various destinations (domestic or overseas) that are within the user's budget and are available from 1 Jun. 2015 to 5 Jun. 2015. Embodiments of the invention advantageously facilitate easier planning of vacations as the user only needs to input his overall travel budget, period of travel and origin location, and an appropriate travel recommendation is generated based on reliable sources of data (i.e. electronic payment transaction data and segment data).

Step 112 involves transmitting the travel recommendation to a user output module to provide the travel recommendation to the user.

The steps of method 100 are in no particular order. For example, step 108 may be performed before step 102. Steps 102, 104 and 106 may be performed regularly so that the recommendation data is up-to-date.

The steps of method 100 provide a travel recommendation based on the recommendation data and the user input data. However, in this case, the travel recommendation is not tailored to the user's preferences. In other words, the travel recommendation is not a “targeted” recommendation. A “targeted” travel recommendation is selective in the sense that the travel recommendation that is provided to the user is more likely to appeal to him than a generic “non-targeted” recommendation. Accordingly, in another embodiment of the invention, there is provided a method 200 for providing a “targeted” travel recommendation to a user. This method 200 involves the same steps as method 100 (i.e. steps 102, 104, 106, 108, 110 and 112), but includes additional steps which will now be described in detail.

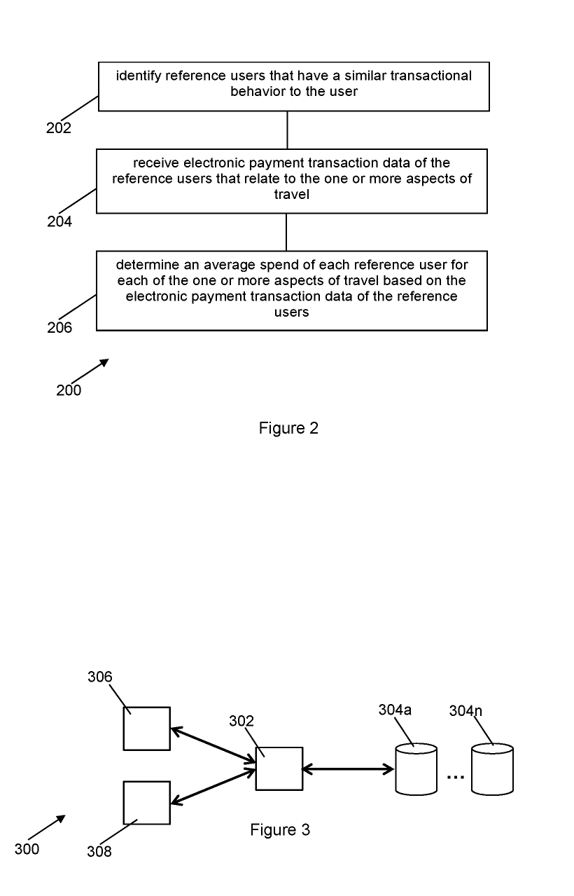

FIG. 2 shows a flow chart illustrating the additional steps in method 200 for providing a “targeted” travel recommendation to a user. At step 202, the recommendation module is used to identify reference users that have a similar transactional behavior to the user. The transactional behavior seeks to quantify the spending pattern of consumers, and may be defined by “an amount of money spent within a particular period of time for a particular aspect of travel”. Alternatively or in addition, the transactional behavior may be defined by “a frequency of electronic payment transactions” and “ticket size of electronic payment transactions”.

The step 202 of identifying reference users that have a similar transactional behavior to the user may include the following sub-steps: (i) obtaining transactional behavior of the user; (ii) obtaining transactional behavior of other users; and (iii) using the recommendation module to compare the transactional behavior of the user with the transactional behavior of the other users to identify a group of users (“the reference users”) that have a similar transactional behavior to the user. In other words, the “reference users” are a subset of the “other users”; “reference users” have transactional behaviour similar to that of the user, while the remaining users that are not “reference users” have transactional behaviour different from that of the user.

In this context, “similar” transactional behaviour may be defined by a pre-defined range. For example, if Mr X's average spend in restaurants is $y, customers that spend $0.9 y-1.1 y are considered to have “similar transactional behavior” and may be considered as “reference users”. Accordingly, the step of comparing the transactional behavior of the user with the transactional behavior of the other users may involve the step of comparing an amount of money spent within a particular period of time for a particular aspect of travel. If the amount of money spent within the particular period of time for the particular aspect of travel by a particular user is within a pre-defined range of the amount of money spent within the particular period of time for the particular aspect of travel by the user, that particular user can be considered as a “reference user”.

The step of obtaining the transactional behavior of the user may comprise: (a) obtaining, from the user input module, the user's identity for uniquely identifying the user; (b) obtaining historical data corresponding to the identified user; and (c) deriving, using the recommendation module, the transactional behavior of the user based on the historical data corresponding to the identified user. The user's identity may include at least one of: an account number, a unique identifier and cardholder identification data. The historical data may comprise historical travel data and/or historical electronic payment transaction data.

The step of obtaining the transactional behavior of the other users may comprise: (a) obtaining historical data corresponding to the other users; and (b) deriving, using the recommendation module, the transactional behavior of the other users based on the historical data corresponding to the other users. The historical data may comprise historical travel data and/or historical electronic payment transaction data.

Turning back to method 200, at step 204, electronic payment transaction data of the reference users (who are identified at step 202 above) that relate to the one or more aspects of travel is received. At step 206, the recommendation module is used to determine an average spend of each reference user for each of the one or more aspects of travel based on the electronic payment transaction data of the reference users. Current techniques known in the art may be used to determine the average spend. The spend may be averaged over a pre-defined period of time, e.g. per day, per week, per month, etc. In addition to generating the travel recommendation based on the recommendation data and the user input data, the travel recommendation is also based on the determined average spend of each reference user for each of the one or more aspects of travel. In this manner, the generated travel recommendation is considered “targeted” as the travel recommendation takes into account the transactional behavior of the user. In particular, users (i.e. the “reference users”) that share a similar transactional behavior with the user are identified. It is assumed that consumers with similar transactional behavior have similar travel preferences. As such, the average spend of the reference users is used as a basis for providing the targeted travel recommendation. Thus, the travel recommendation is not only within a customer's budget but should also appeal to him based on his transactional behavior.

In an implementation, the electronic payment transaction data of the reference users corresponds to payment transactions conducted non-locally/overseas, and the average spend of each reference user comprises non-local/overseas spending. In this context, “non-local” and “overseas” refers to payment transactions conducted outside the reference's city/state/country of residence. For example, if the travel recommendation is for overseas travel, the “overseas” electronic payment transaction data is from countries that the user is not currently residing in. If the travel recommendation is for domestic travel, the “overseas” electronic payment transaction data is from states that the user is not currently residing in. By taking into account “non-local” and “overseas” electronic payment transaction data, it is expected that a more accurate travel recommendation is generated since the data corresponds to electronic payments conducted when a consumer is travelling. Consumers' spend behavior may differ when they are travelling compared to when they are in their home state/country.

To provide an illustration, assume the reference customers' average spend per day when overseas is “$100 for lodging”. Continuing from the earlier example where the user's travel input is: “$2000 overall budget for a vacation; 5 days of vacation starting 1 Jun. 2015 and return 5 Jun. 2015; and current location is Germany”. And again assuming that the user wishes to obtain a recommendation for lodging only. Accordingly, the travel recommendation may be a list of all hotels in various destinations that are within his overall budget of $2000 and costs more or less $100 per day and are available from 1 Jun. 2015 to 5 Jun. 2015. The travel recommendation portal does not recommend hotels that fall within his budget but have a significant price difference (e.g. a budget hotel that costs $20). This is because it is assumed that the reference customers' average spend per day when overseas provides an accurate reflection/prediction of how the customer will spend when overseas.

For a more selective travel recommendation, the user may provide additional inputs. For example, the user can provide, through the user input module, additional input data such as (i) length of travel period, (ii) desired class of travel (economy, business, luxury, etc.), (iii) desired destination(s), and (iv) distribution of the overall travel budget among the one or more aspects of travel. The travel recommendation is based on the additional user input data, in addition to the recommendation data and the user input data.

With regard to the distribution of the overall travel budget among the one or more aspects of travel, the user can choose to allocate a certain percentage of his overall budget to the various aspects of travel (e.g. 40% to transport, 40% to accommodation and 20% to dining). In such a case, the travel recommendation that is generated takes into account the budget limitations in each aspect of travel.

The user can also provide other additional inputs such as specific preferences or priority to certain aspects of travel. For example, a user may not mind paying more for a hotel that has a better location. As such, the travel recommendation can be modified to give priority to “location” over “price”.

The travel recommendation that is generated may comprises a plurality of options in one or more aspects of travel. That is, the various combinations and permutations of the travel recommendation are not limited as long as the combined/consolidated travel recommendation adheres to the user's input (i.e. criteria). The pool of recommendation data provides the basis for the various combinations and permutations of the travel recommendation. For example, for a certain set of user inputs, three travel recommendations can be provided: (a) economy class flight on ABC airlines and standard hotel room at DEF hotel for 3 days, (b) business class flight on ABC airlines and deluxe hotel room at GHI hotel for 2 days, (c) economy class flight on XYZ airlines, suite at AAA hotel for 1 day and fine-dining at JKL restaurant.

FIG. 3 shows a schematic of a network-based system 300 for providing a travel recommendation to a user according to an embodiment of the invention. The system 300 comprises a purpose-built computing device in the form of a recommendation module 302, one or more databases 304a . . . 304n, a user input module 306 and a user output module 308. Each of the one or more databases 304a . . . 304n are communicatively coupled with the recommendation module 302. The user input module 306 and a user output module 308 may be separate and distinct modules communicatively coupled with the recommendation module 302. Alternatively, the user input module 306 and a user output module 308 may be integrated within a single mobile electronic device (e.g. a mobile phone, a tablet computer, etc.). The mobile electronic device may have appropriate communication modules for wireless communication with the recommendation module 302 via existing communication protocols.

The recommendation module 302 may comprise: at least one processor; and at least one memory including computer program code; the at least one memory and the computer program code configured to, with at least one processor, cause the recommendation module at least to: (A) receive electronic payment transaction data relating to one or more aspects of travel, the aspects of travel comprising: transportation, accommodation and/or dining; (B) receive segment data relating to the one or more aspects of travel, the segment data comprising information corresponding to a plurality of travel segments; (C) generate recommendation data by associating the electronic payment transaction data with the segment data to determine, at least, a price of each of the plurality of travel segments; (D) receive, from a user input module, user input data indicative of (i) overall travel budget, (ii) period of travel and (iii) origin location of the user; (E) generate the travel recommendation based on the recommendation data and the user input data; and (F) transmit the travel recommendation to a user output module to provide the travel recommendation to the user.

In an implementation, the recommendation module 302 may be further caused to: (G) identify reference users that have a similar transactional behavior to the user; (H) receive electronic payment transaction data of the reference users that relate to the one or more aspects of travel; and (I) determine an average spend of each reference user for each of the one or more aspects of travel based on the electronic payment transaction data of the reference users. The travel recommendation is also generated based on the average spend of each reference user for each of the one or more aspects of travel so that the travel recommendation can be considered a “targeted” travel recommendation. The recommendation module 302 may be further caused to perform any of the method steps described above.

The various types of data, e.g. electronic payment transaction data relating to one or more aspects of travel, the segment data relating to the one or more aspects of travel, and the recommendation data, can be stored on a single database (e.g. 304a), or stored in multiple databases (e.g. electronic payment transaction data is stored on database 304a, segment data is stored on database 304n, etc.). The databases 304a . . . 304n may be realized using cloud computing storage modules and/or dedicated servers communicatively coupled with the recommendation module 302.

FIG. 4 depicts an exemplary computer/computing device 400, hereinafter interchangeably referred to as a computer system 400, where one or more such computing devices 400 may be used to facilitate execution of the above-described method for providing a travel recommendation to a user. In addition, one or more components of the computer system 400 may be used to realize the recommendation module 302. The following description of the computing device 400 is provided by way of example only and is not intended to be limiting.

As shown in FIG. 4, the example computing device 400 includes a processor 404 for executing software routines. Although a single processor is shown for the sake of clarity, the computing device 400 may also include a multi-processor system. The processor 404 is connected to a communication infrastructure 406 for communication with other components of the computing device 400. The communication infrastructure 406 may include, for example, a communications bus, cross-bar, or network.

The computing device 400 further includes a main memory 408, such as a random access memory (RAM), and a secondary memory 410. The secondary memory 410 may include, for example, a storage drive 412, which may be a hard disk drive, a solid state drive or a hybrid drive and/or a removable storage drive 414, which may include a magnetic tape drive, an optical disk drive, a solid state storage drive (such as a USB flash drive, a flash memory device, a solid state drive or a memory card), or the like. The removable storage drive 414 reads from and/or writes to a removable storage medium 444 in a well-known manner. The removable storage medium 444 may include magnetic tape, optical disk, non-volatile memory storage medium, or the like, which is read by and written to by removable storage drive 414. As will be appreciated by persons skilled in the relevant art(s), the removable storage medium 444 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 440. Examples of a removable storage unit 422 and interface 440 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 422 and interfaces 440 which allow software and data to be transferred from the removable storage unit 422 to the computer system 400.

The computing device 400 also includes at least one communication interface 424. The communication interface 424 allows software and data to be transferred between computing device 400 and external devices via a communication path 426. In various embodiments of the inventions, the communication interface 424 permits data to be transferred between the computing device 400 and a data communication network, such as a public data or private data communication network. The communication interface 424 may be used to exchange data between different computing devices 400 which such computing devices 400 form part an interconnected computer network. Examples of a communication interface 424 can include a modem, a network interface (such as an Ethernet card), a communication port (such as a serial, parallel, printer, GPIB, IEEE 1393, RJ35, USB), an antenna with associated circuitry and the like. The communication interface 424 may be wired or may be wireless. Software and data transferred via the communication interface 424 are in the form of signals which can be electronic, electromagnetic, optical or other signals capable of being received by communication interface 424. These signals are provided to the communication interface via the communication path 426.

As shown in FIG. 4, the computing device 400 further includes a display interface 402 which performs operations for rendering images to an associated display 430 and an audio interface 432 for performing operations for playing audio content via associated speaker(s) 434.

As used herein, the term “computer program product” may refer, in part, to removable storage medium 444, removable storage unit 422, a hard disk installed in storage drive 412, or a carrier wave carrying software over communication path 426 (wireless link or cable) to communication interface 424. Computer readable storage media refers to any non-transitory, non-volatile tangible storage medium that provides recorded instructions and/or data to the computing device 400 for execution and/or processing. Examples of such storage media include magnetic tape, CD-ROM, DVD, Blu-Ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 400. Examples of transitory or non-tangible computer readable transmission media that may also participate in the provision of software, application programs, instructions and/or data to the computing device 400 include radio or infra-red transmission channels as well as a network connection to another computer or networked device, and the Internet or Intranets including e-mail transmissions and information recorded on Websites and the like.

The computer programs (also called computer program code) are stored in main memory 408 and/or secondary memory 410. Computer programs can also be received via the communication interface 424. Such computer programs, when executed, enable the computing device 400 to perform one or more features of embodiments discussed herein. In various embodiments, the computer programs, when executed, enable the processor 404 to perform features of the above-described embodiments. Accordingly, such computer programs represent controllers of the computer system 400.

Software may be stored in a computer program product and loaded into the computing device 400 using the removable storage drive 414, the storage drive 412, or the interface 440. Alternatively, the computer program product may be downloaded to the computer system 400 over the communications path 426. The software, when executed by the processor 404, causes the computing device 400 to perform functions of embodiments described herein.

It is to be understood that the embodiment of FIG. 4 is presented merely by way of example. Therefore, in some embodiments one or more features of the computing device 400 may be omitted. Also, in some embodiments, one or more features of the computing device 400 may be combined together. Additionally, in some embodiments, one or more features of the computing device 400 may be split into one or more component parts.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for providing a travel recommendation to a user, the method comprising:
receiving electronic payment transaction data relating to one or more aspects of travel, the aspects of travel comprising: transportation, accommodation and/or dining;
receiving segment data relating to the one or more aspects of travel, the segment data comprising information corresponding to a plurality of travel segments;
generating, using a recommendation module, recommendation data by associating the electronic payment transaction data with the segment data to determine, at least, a price of each of the plurality of travel segments;
receiving, from a user input module, user input data indicative of (i) overall travel budget, (ii) period of travel and (iii) origin location of the user;
generating, using the recommendation module, the travel recommendation based on the recommendation data and the user input data; and
transmitting the travel recommendation to a user output module to provide the travel recommendation to the user.

2. The method as claimed in claim 1, further comprising:
identifying, using the recommendation module, reference users that have a similar transactional behavior to the user;
receiving electronic payment transaction data of the reference users that relate to the one or more aspects of travel; and
determining, using the recommendation module, an average spend of each reference user for each of the one or more aspects of travel based on the electronic payment transaction data of the reference users,
wherein the travel recommendation is based on the average spend of each reference user for each of the one or more aspects of travel, in addition to the recommendation data and the user input data.

3. The method as claimed in claim 2, wherein the electronic payment transaction data of the reference users corresponds to payment transactions conducted overseas, and the average spend of each reference user comprises overseas spending.

4. The method as claimed in claim 2, wherein the step of identifying reference users that have a similar transactional behavior to the user comprises:
obtaining transactional behavior of the user;
obtaining transactional behavior of other users; and
comparing, using the recommendation module, the transactional behavior of the user with the transactional behavior of the other users to identify the reference users that have a similar transactional behavior to the user.

5. The method as claimed in claim 4, wherein the step of obtaining the transactional behavior of the user comprises:
receiving, from the user input module, the user's identity for uniquely identifying the user;
obtaining historical data corresponding to the identified user; and
determining, using the recommendation module, the transactional behavior of the user based on the historical data corresponding to the identified user.

6. The method as claimed in claim 4, wherein the step of obtaining the transactional behavior of the other users comprises:
obtaining historical data corresponding to the other users; and
determining, using the recommendation module, the transactional behavior of the other users based on the historical data corresponding to the other users.

7. The method as claimed in claim 4, wherein the transactional behavior is defined at least by: an amount of money spent within a particular period of time for a particular aspect of travel.

8. The method as claimed in claim 7, wherein the step of comparing the transactional behavior of the user with the transactional behavior of the other users comprises comparing the amount of money spent within the particular period of time for the particular aspect of travel, and wherein the amount of money spent within the particular period of time for the particular aspect of travel by the reference users is within a pre-defined range of the amount of money spent within the particular period of time for the particular aspect of travel by the user.

9. The method as claimed in claim 5, wherein the historical data comprises historical travel data and/or the electronic payment transaction data.

10. The method as claimed in claim 1, wherein the electronic payment transaction data comprises at least one of: a merchant category code (MCC), transaction date and transaction amount of an electronic payment transaction.

11. The method as claimed in claim 5, wherein the user's identity comprises at least one of: an account number, a unique identifier and cardholder identification data.

12. The method as claimed in claim 1, further comprising:
receiving, from the user input module, additional user input data indicative of: (i) length of travel period, (ii) desired class of travel, (iii) desired destination, and (iv) distribution of the overall travel budget among the one or more aspects of travel,
wherein the travel recommendation is based on the additional user input data, in addition to the recommendation data and the user input data.

13. The method as claimed in claim 1, wherein the travel recommendation comprises one or more of: (i) a recommended travel destination, (ii) a recommended transportation to the destination, (iii) a recommended accommodation at the destination and (iv) a recommended restaurant at the destination.

14. The method as claimed in claim 1, wherein each travel segment defines a discrete portion of a travel itinerary relating to either transportation, accommodation or dining.

15. The method as claimed in claim 14, wherein the segment data comprises one or more of: a price, validity period, location, and class corresponding to each travel segment.

16. The method as claimed in claim 1, wherein associating the electronic payment transaction data with the segment data comprises linking electronic payment transaction data corresponding to a payment transaction with segment data corresponding to a travel segment that was paid through the payment transaction.

17. A system for providing a travel recommendation to a user, comprising a recommendation module, the recommendation module comprising:
at least one processor; and
at least one memory including computer program code;
the at least one memory and the computer program code configured to, with at least one processor, cause the recommendation module at least to:
receive electronic payment transaction data relating to one or more aspects of travel, the aspects of travel comprising: transportation, accommodation and/or dining;
receive segment data relating to the one or more aspects of travel, the segment data comprising information corresponding to a plurality of travel segments;
generate recommendation data by associating the electronic payment transaction data with the segment data to determine, at least, a price of each of the plurality of travel segments;
receive, from a user input module, user input data indicative of (i) overall travel budget, (ii) period of travel and (iii) origin location of the user;
generate the travel recommendation based on the recommendation data and user input data; and
transmit the travel recommendation to a user output module to provide the travel recommendation to the user.

18. The system as claimed in claim 17, wherein the recommendation module is further caused to:
identify reference users that have a similar transactional behavior to the user;
receive electronic payment transaction data of the reference users that relate to the one or more aspects of travel; and
determine an average spend of each reference user for each of the one or more aspects of travel based on the electronic payment transaction data of the reference users,
wherein the travel recommendation is based on the average spend of each reference user for each of the one or more aspects of travel, in addition to the recommendation data and the user input data.

19. The system as claimed in claim 17, further comprising a database communicatively coupled with the recommendation module, the database having stored thereon at least one of: the electronic payment transaction data relating to one or more aspects of travel, the segment data relating to the one or more aspects of travel, and the recommendation data.
